(19) United States
(12) Patent Application Publication
(10) Pub. No.: US 2021/0378274 A1
(43) Pub. Date: Dec. 9, 2021

(54) Quality-Improving Agent for Food

(71) Applicant: SUNNYHERZ JAPAN CO.,LTD., Takatsuki-shi (JP)

(72) Inventors: Kazuyoshi Nukutsuma, Nishinomiya-shi (JP); Kenji Tatsuno, Yamatokoriyama-shi (JP); Yuko Naka, Takatsuki-shi (JP)

(21) Appl. No.: 17/288,135

(22) PCT Filed: Oct. 24, 2018
(86) PCT No.: PCT/JP2018/039541

§ 371 Date: Apr. 23, 2021

(51) Int. Cl. A23L 19/00; A23J 3/08; A23J 3/16; A23J 3/18; A23L 5/20

(52) U.S. Cl. CPC A23L 19/00; A23J 3/08; A23V 2002/00; A23J 3/18; A23L 5/23; A23J 3/16

(57) ABSTRACT

To provide a modified protein having excellent gel forming property and chewy feel, a material for mineral preparation is a fired product of seed coats, leaves or stalks of buckwheat and is added to protein.

### CROSS-REFERENCE TO RELATED APPLICATION

This application is the United States national phase of International Application No. PCT/JP2018/039541 filed Oct. 24, 2018, the disclosure of which is hereby incorporated by reference in its entirety.

### TECHNICAL FIELD

This invention relates to a quality-improvement agent and a method for quality-improvement for protein food. Further in detail, it relates to a quality-improvement agent for food which its material is protein food and improves texture and yield of the processed food and a method for quality-improvement thereof.

### BACKGROUND ART

Plant protein, for example gluten, which is a wheat protein, is a plant protein having many functions such as dough forming ability and heat-gelling ability, and is widely used as the main material or an auxiliary material for food such as breads, noodles, and fish paste products. However, though the gelling of gluten is promoted by heating and its viscoelasticity develops, since the gel strength is low compared to meat products, the chewy feel when eaten is unsatisfying. Thus, sufficient performance as a substitute product for meat is not ensured.

Nonpatent literature 1 (“Studies on Heat-induced Aggregation of Wheat Gluten” Takahiko Anno, Journal of Japanese Society of Food and Nutrition, Vol 34, No. 2 127-132, 1981) discloses a conventional method using reducing agents such as sodium bisulfite for wheat protein to improve viscoelasticity of protein.

Patent literature 1 (Japanese Patent Application H07-79707) discloses a method to improve the chewy feel of noodles by a method allowing the enzyme (transglutaminase) to act.

Nonpatent literature 2 (“Science of Wheat” Seiichi Nagao, Asakura Publishing Co., Ltd., 157, 1995) discloses a method of providing the chewy feel by modifying gluten with brine (alkaline agent) as in chinese noodles (Seiichi Nagao, Science of Wheat, Asakura Publishing Co., Ltd., 157, 1995).

However, in nonpatent literature 1, by the method with a reducing agent, there is a problem in quality stability due to the gluten being oxidized by oxygen in air and the physical property of gluten being restored. Patent literature 1 is often difficult to control the physical property by temperature and time of the enzyme reaction and requires skills of the operator for use with stability.

Nonpatent literature 2 has restriction in use such that flavor peculiar to alkaline agents being generated and browning, and thus lacks versatility. As stated above, there was yet no improving method with satisfactory.

The object of the invention is to provide a modification method for protein having excellent gel forming property and chewy feel, and to provide food containing said modified protein.

### SUMMARY OF THE INVENTION

As a result of intensive studies, to achieve the above object, it was found that protein food containing a material for mineral preparation obtained by firing plants as an active ingredient bears excellent texture very rich in viscoelasticity and have completed the present invention.

The present invention relates to a food quality-improvement agent for protein food containing a material for mineral preparation obtained by firing plants as an active ingredient.

Namely, the present invention relates to a food quality-improvement agent for protein food containing a material for mineral preparation obtained by firing plants as an active ingredient, wherein material derived from buckwheat is suitable for the material of the mineral preparation and is obtained by firing its seed coats, leaves or stalks.

Proteins of interest in the modification method of the present invention are animal, plant-derived, for example, whey protein such as beta-lactoglobulin and alpha-lactalbumin, wheat protein such as gluten, and soy protein. Moreover, it may also be modified by a mixture of two or more proteins, peptides and amino acids.

It is extremely useful in industry that with the food quality-improvement agent and the quality-improving method for protein food of the present invention, addition to protein food improves the viscoelasticity of processed meat food of livestock meat or seafood meat and the like, especially food processed using livestock as material, and alternative livestock meat or livestock meat can be greatly reduced.

### DETAILED DESCRIPTION OF THE INVENTION

The plant mineral preparation is characterized by preferably being added to be 50 parts by weight or less to 100 parts by weight of protein. It is effective even with a slight addition, but addition exceeding 50 parts by weight does not increase economic effect.

Buckwheat, which is the material, is an annual plant of polygonaceae family and is grown among the Temperate Zone over the world. The stalks are flexible, upright and round shaped, the height is about 40 to 70cm, and the leaves are triangular heart type and have long leaves. In early fall, white flowers are clustered closely at the end of the stalks and bears three-ridge shaped black peel fruits. In this invention, the fruits are peeled and besides seed coats of the buckwheat, the whole plant such as leaves and stalks are contained.

The present invention contains a material for mineral preparation obtained by firing plants as an active ingredient, and ash (fired material) obtained by firing the whole plant such as seed coats, stalks, and leaves are used. The firing temperature is 500 to 900° C. When it is lower than 500° C., due to insufficient decomposition of the organic substance, problems such as in appearance due to discolor and in taste etc., which is derived especially from polyphenol, the composition of the decomposition product, are caused. On the other hand, when it exceeds 900° C., due to decomposition of alkaline earth metal, especially organic acid compounds having a chelating ability such as phytic acid which sequester the polyvalent metals, its inherent effect decreases.

In the method of this invention, addition to food protein may be directly added to the material, or may be pre-dissolved in water of the manufacturing process, then added.

In this invention, frozen food of wheat protein, processed granular product, processed powder product and the like may be considered as food protein. As far as its effect is not inhibited, the quality-improving agent in this invention may be combined with seasonings such as salt, sodium glutamate, mirin, and cooking sake, sweeteners such as sugar, glucose, xylose, starch syrup, aspartame, acidulants, preservatives, antioxidants, thickening stabilizers or modified starch and the like besides the above ingredients.

### EXAMPLES

Preparation of Plant Mineral Preparation (Buckwheat) 1

After the seed coats or leaves, stalks of buckwheat, which is a plant were put into an electric furnace and raised to 800° C., it was fired for an hour and the fired product was obtained. After cooling 100 g of the obtained fired product to room temperature, 900 g of warm water was added and was stirred and extracted for 30 minutes. Then, after adding 700 parts by mass of processed starch (PB5000: manufactured by Nippon Starch Chemical Co., Ltd.) to 300 parts by mass of the extract and mixing, it was dried until a moisture content of 5% with a tunnel dryer and a powder product was obtained.

Preparation of Plant Mineral Preparation (Sesame) 2

After the seed coats or leaves, stalks of sesame, which is a plant were put into an electric furnace and raised to 800° C., it was fired for an hour and the fired product was obtained. After cooling 100 g of the obtained fired product to room temperature, 900 g of warm water was added and was stirred and extracted for 30 minutes. Then, after adding 700 parts by mass of processed starch (PB5000: manufactured by Nippon Starch Chemical Co., Ltd.) to 300 parts by mass of the extract and mixing, it was dried until a moisture content of 5% with a tunnel dryer and a powder product was obtained.

Preparation of Plant Mineral Preparation (Camellia) 3

After the woodchip of camellia, which is a plant were put into an electric furnace and raised to 800° C., it was fired for an hour and the fired product was obtained. After cooling 100 g of the obtained fired product to room temperature, 900 g of warm water was added and was stirred and extracted for 30 minutes. Then, after adding 700 parts by mass of processed starch (PB5000: manufactured by Nippon Starch Chemical Co., Ltd.) to 300 parts by mass of the extract and mixing, it was dried until a moisture content of 5% with a tunnel dryer and a powder product was obtained.

Test 1

Pasting liquid was obtained by adding 100% by mass of purified water and 5 to 50% by mass of plant extract powder to 50% by mass of wheat protein (Fmerit A2 Nagata Sangyo Co., Ltd.) and kneading until uniform using food cutter (CutterR100 robot coupe). The obtained pasting liquid was filled in a vinylidene chloride tube of inner diameter 30 mm×length 150 mm×thickness of 0.1 mm and was heated using a constant temperature water bath (manufactured by Zouya Corporation, product name: IH unit) at 90° C. for 45 minutes, then cooled and preserved for 24 hours at 10° C. After preservation, the breaking strength (g/cm²) as gel strength was measured in the following condition using a physical property measuring device (manufactured by Rheotech Co., Ltd., model: FUDOH RHEO METER RT-3002D) and its properties were observed. This is taken as Example 1.

Test 2.3

Besides using soy protein (Solpy 4000H Nisshin Oillio Group, Inc.) and whey protein (Enlact HG Nippon Shinyaku Co., Ltd.) as a substitute for wheat protein as food protein, it was processed similarly as Example 1 (these are taken as Examples 2 to 5). Approximately 40g was obtained.

### Comparative examples 1 to 5

A similar test to the Example was given without adding plant extract powder to food protein (wheat protein, soy protein, whey protein).

Test 4.5

A similar test to the Example was given using wheat protein as food protein, but using sesame and camellia as plant extract powder.

Physical property measurement condition

The physical property was measured in the following condition.
Plunger: for compression D ϕ 10 mm, ·Table speed: 10 cm/min
Sensitivity: 2 kg
Recorder: HIOKI. Chart speed: 180 mm/min
Sensitivity 0.5V
Sample shape: diameter 48 mm diameter×height 30 mm

TABLE 1

| | | Comparative | | | |
|---|---|---|---|---|---|
| Test 1 | | example 1 | Example 1 | | |
| Wheat | The amount of buckwheat | 0 | 5 | 10 | 50 |
| protein | extract added (%) | | | | |
| | Breaking strength (g/cm²) | 933 | 1227 | 1735 | 1603 |
| | Gel forming property | C | B | A | A |
| | | Comparative | | | |
| Test 2 | | example 2 | Example 2 | | |
| Soy | The amount of buckwheat | 0 | 5 | 10 | 50 |
| protein | extract added (%) | | | | |
| | Breaking strength (g/cm²) | 720 | 890 | 1080 | 1000 |
| | Gel forming property | C | B | B | B |
| | | Comparative | | | |
| Test 3 | | example 3 | Example 3 | | |
| Whey | The amount of buckwheat | 0 | 5 | 10 | 50 |
| protein | extract added (%) | | | | |
| | Breaking strength (g/cm²) | 783 | 1250 | 1050 | 1025 |
| | Gel forming property | C | B | B | B |
| | | Comparative | | | |
| Test 4 | | example 4 | Example 4 | | |
| Wheat | The amount of sesame | 0 | 5 | 10 | 50 |
| protein | extract added (%) | | | | |
| | Breaking strength (g/cm²) | 933 | 984 | 980 | 1020 |
| | Gel forming property | C | C | C | B |
| | | Comparative | | | |
| Test 5 | | example 5 | Example 5 | | |
| Wheat | The amount of camellia | 0 | 5 | 10 | 50 |
| protein | extract added (%) | | | | |
| | Breaking strength (g/cm²) | 933 | 980 | 1000 | 1025 |
| | Gel forming property | C | C | B | B |

Assessment

The obtained breaking strength (g/cm²) and its properties were sorted based on the following 4 stages and the gel forming, and the gel forming property (strength) was assessed.

Assessment A: A gel having a breaking strength of 1400 g/cm² or more, is extremely hard, and has elasticity.

Assessment B: A gel having a breaking strength of 1000 to 1200 g/cm² or more, is hard, and has elasticity.

Assessment C: A gel having a breaking strength of 1000 g/cm² or less, is soft, and has weak elasticity.

The property which the protein has can be safely and efficiently, and further, even easily modified by the modification method for protein of the present invention. It is effective if the plant ash material is plant-derived, but material derived especially from buckwheat may be suitably used.

This invention is extremely useful in industry that addition to protein food improves the viscoelasticity of processed meat food of livestock meat or seafood meat and the like, especially food processed using livestock as material, and alternative livestock meat or livestock meat can be greatly reduced.

1. A food quality-improvement agent for protein-containing food, comprising a material for mineral preparation obtained by firing plants as an active ingredient, wherein the material is a fired product of seed coats, leaves or stalks, and said proetin is a plant protein or whey protein.

2. (canceled)

3. The food quality-improvement agent for protein-containing food of claim 1, wherein said plant protein is wheat protein.

4. The food quality-improvement agent for preotein-containing food of claim 1, wherein said plant protein is soy protein.

5. (canceled)

6. (canceled)
